(19) United States
(12) Patent Application Publication
(10) Pub. No.: US 2010/0227942 A1
(43) Pub. Date: Sep. 9, 2010

(54) DUAL-CURE FORMULATIONS WITH COMPONENTS CONTAINING URETDIONE GROUPS

(76) Inventors: Emmanouil Spyrou, Schermbeck (DE); Holger Loesch, Herne (DE)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/682,993

(22) PCT Filed: Oct. 15, 2007
(86) PCT No.: PCT/EP2008/063846

§ 371 Date: Apr. 14, 2010

(30) Foreign Application Priority Data
Dec. 18, 2007 (DE) 102007061012.4

(51) Int. Cl. C08F 2/46; C08L 75/00

(52) U.S. Cl. 522/174; 524/555

(57) ABSTRACT

The present invention relates to novel formulations which are thermally curable and curable by actinic radiation, known as dual-cure formulations. The present invention also relates to the use, for the production of pigmented and pigment-free coating materials, or else for adhesives and sealants, of the novel formulations that are curable thermally and curable by actinic radiation.

The present invention relates to novel formulations which are thermally curable and curable by actinic radiation, known as dual-cure formulations. The present invention also relates to the use, for the production of pigmented and pigment-free coating materials, or else for adhesives and sealants, of the novel formulations that are curable thermally and curable by actinic radiation.

Formulations curable by actinic radiation are known.

Ethylenically unsaturated prepolymers are described by way of example in P. K. T. Oldring (Ed.), “Chemistry and Technology of UV- and EB-Formulations for Coatings, Inks and Paints”, Vol. II. SITA Technology, London 1991, examples being those based on epoxy acrylates (pages 31 to 68), on urethane acrylates (pages 73 to 123) and on melamine acrylates (pages 208 to 214). Formulations of this type are also often mentioned in the patent literature, and examples that may be mentioned are JP 62110779 and EP 947 565.

The coating of metallic substrates is a particular problem for radiation-curable formulations, since shrinkage processes can often lead to loss of adhesion. Adhesion promoters comprising phosphoric acid are therefore often used for these substrates. Examples of this are U.S. Pat. No. 5,128,387 (coating of beer cans) and JP 2001172554 (coating of various cans).

It is known that epoxy acrylates exhibit excellent adhesion and also provide good corrosion prevention on metal substrates. However, a disadvantage of these coatings is low formability after hardening. For some coating technologies, e.g. coil coating, the formability of the coated workpieces without cracking of the coating is of critical importance. The aromatic content of these coatings moreover makes them susceptible to yellowing.

WO 03/022945 describes low-viscosity radiation-curable formulations for metal substrates, based on radiation-curable resins, on monofunctional reactive diluents and on acidic adhesion promoters. The resins used here are conventional marketed products obtainable from various suppliers.

EP 902 040, too, relates to radiation-curable formulations. It describes urethane (meth)acrylates with monofunctional esters of an unsaturated carboxylic acid, these having been esterified with alcohols, where these contain a carbocycle or a heterocycle.

However, many of the systems known from the prior art exhibit disadvantages, and in particular the hardening of three-dimensional substrates in the shadow zone is difficult or impossible to achieve.

For some time, dual-cure systems have therefore been propagated which also include other curing methods alongside radiation-curing. Examples are WO2001/46286, WO200146285, WO2001/42329, WO2001/23453, WO2000/39183, EP1138710, EP1103572, EP1085065, EP928800. In these, the reaction of isocyanate-functionalized binder constituents with hydroxy-functional components is described, leading to additional crosslinking.

If free isocyanates are used here, as for example in WO2001/46286, the result is a 2-component formulation with restricted pot life.

If, in contrast, externally blocked isocyanates are used (e.g. WO2001/23453), blocking agent is released into the environment during the hardening reaction, and this is undesirable for environmental reasons.

WO 03/016376 describes the use of internally blocked isocyanates (uretdiones) in dual-cure systems. The use of uretdione-containing components there leads to improved intermediate adhesion, but in the examples listed it has no effect on the hardness and scratch resistance of the coating (Examples 3, 4 and V2). There is no example giving the performance of the coating solely with thermal hardening, without radiation curing (i.e. simulating the shadow regions).

It is an object of the present invention to develop formulations curable by actinic radiation and curable thermally, which after thermal hardening either with or without prior radiation curing give an adhesive bond or a seal which complies with minimum requirements, i.e. is non-tack, flexible and chemicals-resistant. This formulation is moreover intended to be free of blocking agents, for environmental reasons, and to be hardenable below 160° C., so that it can also be used for heat-sensitive substrates.

Surprisingly, it has been found that the formulations according to the invention achieve the object.

The present invention provides thermally curable and radiation-curable formulations composed of
A) from 5 to 90% by weight of at least one radiation-curable component, which can also contain OH groups,
B) from 10 to 90% by weight of at least one component containing uretdione groups, which can also contain OH groups and/or radiation-curable groups,
C) from 0.1 to 5% by weight of at least one tetralkylammonium salt and/or phosphonium salt with halogens, hydroxides, alcoholates or organic or inorganic acid anions, as counter-ion,
   and
   from 0.1 to 5% by weight of at least one co-catalyst, selected from
C1) at least one epoxide
   and/or
C2) at least one metal acetylacetonate.

These materials can moreover also comprise at least one of the following components, alone or in a mixture:
D) from 0.1 to 10% by weight of at least one adhesion promoter,
E) from 0.2 to 10% by weight of at least one photoinitiator,
F) from 0.1 to 10% by weight of at least one acid,
G) from 1 to 40% by weight of monomers and/or polymers and/or oligomers containing hydroxy groups,
H) from 0.01 to 50% by weight of at least one pigment and/or other additives,
I) from 1 to 70% by weight of at least one solvent.

The thermally curable and radiation-curable formulations according to the invention have the advantage that when hardened correctly by actinic radiation and thermal energy they retain their full properties with regard to freedom from tack, flexibility and chemicals resistance, but that they also comply with minimum requirements when hardened purely thermally. These minimum requirements are freedom from tack, chemicals resistance of at least 20 cycles and Erichsen indentation of at least 7 mm.

The radiation-curable resins of component A) are an essential component of the formulations according to the invention. These involve systems known to the person skilled in the art. The production of radiation-curable resins, oligomers and/or polymers is described by way of example in “Radiation Curing in Polymer Science & Technology, Vol I: Fundamentals and Methods” by J. P. Fouassier, J. F. Rabek, Elsevier Applied Science, London and New York, 1993, Chapter 5, pages 226 to 236, in “Lackharze”, D. Stoye, W. Freitag, Hanser-Verlag, Vienna, 1996, page 85, 94-98, 169 and 265 and in EP 947 565.

As a function of the parent raw material, the resins of component A) can by way of example be epoxy acrylates, polyester acrylates, polyether acrylates, polyacrylate acrylates, and urethane acrylates and/or polyester urethane acrylates, alone or in a mixture. The urethane acrylates can by way of example be based on polyesters or else on polyethers. The corresponding methacrylates are also known. Other polymerizable groups are epoxides and vinyl ethers. These, too, can have been linked to various parent resins. An amount of from 1 to 500 mg KOH/g of OH groups can also be present.

Liquid radiation-curable components, known as reactive diluents, can also be used for A).

Radiation-curable reactive diluents A) and their production are described by way of example in “Radiation Curing in Polymer Science & Technology, Vol I: Fundamentals and Methods” by J. P. Fouassier, J. F. Rabek, Elsevier Applied Science, London and New York, 1993, Chapter 5, pages 237 to 240. These generally involve substances containing methacrylate or acrylate which are liquid at room temperature and therefore are capable of lowering the overall viscosity of the formulation. Examples of these products are in particular isobornyl acrylate, hydroxypropyl methacrylate, trimethylolpropane monoformal acrylate, tetrahydrofurfuryl acrylate, phenoxyethyl acrylate, trimethylenepropane triacrylate, dipropylene glycol diacrylate, tripropylene glycol diacrylate, hexanediol diacrylate, pentaerythritol tetraacrylate, lauryl acrylate, or else propoxylated or ethoxylated variants of these reactive diluents and/or urethanized reactive diluents, such as EBECRYL 1039 (Cytec), and others. It is also possible to use other liquid components capable of reacting under conditions of free-radical polymerization with, for example, vinyl ether or allyl ether.

The amount of A) in the formulation varies from 5 to 90% by weight, preferably from 10 to 50% by weight, based on the entire formulation. Particular preference is given to polyester urethane acrylates. Examples of these are VESTICOAT EP 110 IBOA (product marketed by Evonik Degussa GmbH, Germany, Coatings & Colorants, Difunctional Polyester Urethane Acrylate) and EBECRYL 1256 (product marketed by Cytec). Particular preference is also given to monofunctional reactive diluents, in particular isobornyl acrylate and/or trimethylolpropane monoformal acrylate.

Polyisocyanates containing uretdione groups are well known and are described by way of example in U.S. Pat. No. 4,476,054, U.S. Pat. No. 4,912,210, U.S. Pat. No. 4,929,724, and also EP 0 417 603. A comprehensive overview of industrially relevant processes for the dimerization of isocyanates to uretdiones is provided by J. Prakt. Chem. 336 (1994) 185-200. The reaction of isocyanates to give uretdiones generally takes place in the presence of soluble dimerization catalyst, e.g. dialkylaminopyridines, trialkylphosphines, phosphorous triamides, triazole derivatives or imidazoles. The reaction—optionally carried out in solvents, but preferably in the absence of solvents—is terminated on reaching a desired conversion, by addition of catalyst poisons. Excess monomeric isocyanate is then removed by short-path evaporation. If the catalyst is sufficiently volatile, the reaction mixture can be freed from the catalyst during the course of monomer removal. In this case, it is possible to omit addition of catalyst poisons. A wide range of isocyanates is in principle suitable for the production of polyisocyanates containing uretdione groups. According to the invention, preference is given to use of isophorone diisocyanate (IPDI), hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), methylenediphenyl diisocyanate (MDI), toluidine diisocyanate (TDI) and tetramethylxylylene diisocyanate (TMXDI). Very particular preference is given to IPDI, HDI and H₁₂MDI.

The reaction of these polyisocyanates bearing uretdione groups to give component B) having uretdione groups includes the reaction of the free NCO groups with polymers or monomers containing hydroxy groups, e.g. polyesters, polythioethers, polyethers, polycaprolactams, polyepoxides, polyesteramides, polyurethanes or low-molecular-weight di-, tri- and/or tetraalcohols as chain extenders and, if appropriate, monoamines and/or monoalcohols as chain terminators, and has been frequently described (EP 0 669 353, EP 0 669 354, DE 30 30 572, EP 0 639 598 or EP 0 803 524). Preference is given to polyesters and monomeric dialcohols. Preferred components B) (hardeners) having uretdione groups have less than 5% by weight of free NCO content and from 1 to 25% by weight of uretdione group content (calculated as C₂N₂O₂, molecular weight 84). Component B) having uretdione groups can also have, as well as the uretdione groups, isocyanurate structures, biuret structures, allophanate structures, urethane structures and/or urea structures. Commercially available examples of these components B) (hardeners) containing uretdione groups are VESTAGON BF 1320, VESTAGON, BF 1540 and VESTAGON BF 9030 from Evonik Degussa GmbH.

Component B) having uretdione groups can also contain OH groups and/or radiation-curable groups. If isocyanates containing uretdione groups are reacted with an excess of diols, the result is products containing uretdione groups and containing OH groups. If, in contrast, substances are used in the same reaction which bear not only groups reactive towards isocyanates but also functionalities capable of free-radical polymerization (e.g. hydroxyethyl acrylate), the result is a product containing uretdione groups and having additional radiation-curable groups.

The proportion of component B) containing uretdione groups can be from 10 to 90% by weight, preferably from 20 to 50% by weight, based on the entire formulation. Catalysts used for C) are tetralkylammonium salts and/or phosphonium salts with halogens, with hydroxides, with alcoholates or with organic or inorganic acid anions as counter-ion. Examples of these are:

tetramethylammonium formate, tetramethylammonium acetate, tetramethylammonium propionate, tetramethylammonium butyrate, tetramethylammonium benzoate, tetraethylammonium formate, tetraethylammonium acetate, tetraethylammonium propionate, tetraethylammonium butyrate, tetraethylammonium benzoate, tetrapropylammonium formate, tetrapropylammonium acetate, tetrapropylammonium propionate, tetrapropylammonium butyrate, tetrapropylammonium benzoate, tetrabutylammonium formate, tetrabutylammonium acetate, tetrabutylammonium propionate, tetrabutylammonium butyrate and tetrabutylammonium benzoate and tetrabutylphosphonium acetate, tetrabutylphosphonium formate and ethyltriphenylphosphonium acetate, tetrabutylphosphonium benzotriazolate, tetraphenylphosphonium phenolate and trihexyltetradecylphosphonium decanoate, methyltributylammonium hydroxide, methyltriethylammonium hydroxide, tetramethylammonium hydroxide, tetraethylammonium hydroxide, tetrapropylammonium hydroxide, tetrabutylammonium hydroxide, tetrapentylammonium hydroxide, tetrahexylammonium hydroxide, tetraoctylammonium hydroxide, tetradecylammonium hydroxide, tetradecyltrihexylammonium hydroxide, tetraoctadecylammonium hydroxide, benzyltrimethylammonium hydroxide, benzyltriethylammonium hydroxide, trimethylphenylammonium hydroxide, triethylmethylammonium hydroxide, trimethylvinylammonium hydroxide, methyltributylammonium methanolate, methyltriethylammonium methanolate, tetramethylammonium methanolate, tetraethylammonium methanolate, tetrapropylammonium methanolate, tetrabutylammonium methanolate, tetrapentylammonium methanolate, tetrahexylammonium methanolate, tetraoctylammonium methanolate, tetradecylammonium methanolate, tetradecyltrihexylammonium methanolate, tetraoctadecylammonium methanolate, benzyltrimethylammonium methanolate, benzyltriethylammonium methanolate, trimethylphenylammonium methanolate, triethylmethylammonium methanolate, trimethylvinylammonium methanolate, methyltributylammonium ethanolate, methyltriethylammonium ethanolate, tetramethylammonium ethanolate, tetraethylammonium ethanolate, tetrapropylammonium ethanolate, tetrabutylammonium ethanolate, tetrapentylammonium ethanolate, tetrahexylammonium ethanolate, tetraoctylammonium methanolate, tetradecylammonium ethanolate, tetradecyltrihexylammonium ethanolate, tetraoctadecylammonium ethanolate, benzyltrimethylammonium ethanolate, benzyltriethylammonium ethanolate, trimethylphenylammonium ethanolate, triethylmethylammonium ethanolate, trimethylvinylammonium ethanolate, methyltributylammonium benzylate, methyltriethylammonium benzylate, tetramethylammonium benzylate, tetraethylammonium benzylate, tetrapropylammonium benzylate, tetrabutylammonium benzylate, tetrapentylammonium benzylate, tetrahexylammonium benzylate, tetraoctylammonium benzylate, tetradecylammonium benzylate, tetradecyltrihexylammonium benzylate, tetraoctadecylammonium benzylate, benzyltrimethylammonium benzylate, benzyltriethylammonium benzylate, trimethylphenylammonium benzylate, triethylmethylammonium benzylate, trimethylvinylammonium benzylate, tetramethylammonium fluoride, tetraethylammonium fluoride, tetrabutylammonium fluoride, tetraoctylammonium fluoride, benzyltrimethylammonium fluoride, tetrabutylphosphonium hydroxide, tetrabutylphosphonium fluoride, tetrabutylammonium chloride, tetrabutylammonium bromide, tetrabutylammonium iodide, tetraethylammonium chloride, tetraethylammonium bromide, tetraethylammonium iodide, tetramethylammonium chloride, tetramethylammonium bromide, tetramethylammonium iodide, benzyltrimethylammonium chloride, benzyltriethylammonium chloride, benzyltripropylammonium chloride, benzyltributylammonium chloride, methyltributylammonium chloride, methyltripropylammonium chloride, methyltriethylammonium chloride, methyltriphenylammonium chloride, phenyltrimethylammonium chloride, benzyltrimethylammonium bromide, benzyltriethylammonium bromide, benzyltripropylammonium bromide, benzyltributylammonium bromide, methyltributylammonium bromide, methyltripropylammonium bromide, methyltriethylammonium bromide, methyltriphenylammonium bromide, phenyltrimethylammonium bromide, benzyltrimethylammonium iodide, benzyltriethylammonium iodide, benzyltripropylammonium iodide, benzyltributylammonium iodide, methyltributylammonium iodide, methyltripropylammonium iodide, methyltriethylammonium iodide, methyltriphenylammonium iodide and phenyltrimethylammonium iodide, methyltributylammonium hydroxide, methyltriethylammonium hydroxide, tetramethylammonium hydroxide, tetraethylammonium hydroxide, tetrapropylammonium hydroxide, tetrabutylammonium hydroxide, tetrapentylammonium hydroxide, tetrahexylammonium hydroxide, tetraoctylammonium hydroxide, tetradecylammonium hydroxide, tetradecyltrihexylammonium hydroxide, tetraoctadecylammonium hydroxide benzyltrimethylammonium hydroxide, benzyltriethylammonium hydroxide, trimethylphenylammonium hydroxide, triethylmethylammonium hydroxide, trimethylvinylammonium hydroxide, tetramethylammonium fluoride, tetraethylammonium fluoride, tetrabutylammonium fluoride, tetraoctylammonium fluoride and benzyltrimethylammonium fluoride. These catalysts can be added alone or in a mixture. They can also have been encapsulated or bound to a polymer. It is preferable to use tetraethylammonium benzoate and tetrabutylammonium hydroxide.

The proportion of catalysts C) can be from 0.1 to 5% by weight, preferably from 0.3 to 2% by weight, based on the entire formulation.

Co-catalysts C1) used are epoxides. Examples of compounds used here are glycidyl ethers and glycidyl esters, aliphatic epoxides, diglycidyl ethers based on bisphenol A and glycidyl methacrylates. Examples of these epoxides are triglycidyl isocyanurate (TGIC, trade name ARALDITE 810, Huntsman), mixtures of diglycidyl terephthalate and triglycidyl trimellitate (trade name ARALDITE PT 910 and 912, Huntsman), glycidyl esters of versatic acid (trade name KARDURA E10, Shell), 3,4-epoxy-cyclohexylmethyl 3′,4′-epoxycyclohexanecarboxylate (ECC), diglycidyl ether based on bisphenol A (trade name EPIKOTE 828, Shell) ethylhexyl glycidyl ether, butyl glycidyl ether, pentaerythritol tetraglycidyl ether, (trade name POLYPDX R16, UPPC AG), and also other Polypox grades having free epoxy groups. It is also possible to use mixtures. Preference is given to use of ARALDITE PT 910 and 912.

Other co-catalysts C2) that can be used are metal acetylacetonates. Examples of these are zinc acetylacetonate, lithium acetylacetonate and tin acetylacetonate, alone or in a mixture. It is preferable to use zinc acetylacetonate.

The proportion of co-catalysts C1) and/or C2) can be from 0.1 to 5% by weight, preferably from 0.3 to 2% by weight, based on the entire formulation.

The formulations according to the invention can optionally comprise adhesion promoters D). Adhesion promoters for radiation-curable formulations for metallic substrates are generally composed of phosphoric acid and/or phosphonic acid and/or their reaction products (e.g. esters) with functionalized acrylates. While the free phosphoric acid groups are responsible for direct adhesion to the metal, the acrylate groups provide a bond to the coating matrix. These products are described by way of example in WO 01/98413, in JP 08231564, and in JP 06313127, the disclosure of which is incorporated herein by way of reference.

Typical commercially available products are EBECRYL 168, 169 and 170 from Cytec, ALDITOL Vxl 6219 from VIANOVA, CD 9050 and CD 9052 from Sartomer, SIPOMER PAM-100, SIPOMER PAM-200 and SIPOMER PAM-300 from Rhodia and GENORAD 40 from Rahn.

If D) is present in the formulation, its amount is from 0.1 to 10% by weight, preferably from 1 to 5% by weight, based on the entire formulation.

Photoinitiators E) can likewise be present in the formulations according to the invention. Suitable photoinitiators and their preparation are described by way of example in “Radiation Curing in Polymer Science & Technology, Vol II: Photoinitiating Systems” by J. P. Fouassier, J. F. Rabek, Elsevier Applied Science, London and New York, 1993. These preferably involve α-hydroxy ketones or derivatives of the same. If the photoinitiators are present, their amounts present can be from 0.2 to 10% by weight, based on the entire formulation. Suitable photoinitiators are obtainable with trade names LUCERIN (BASF), IRGACURE and DAROCUR (Ciba).

Acids, mentioned under F), are any of the substances, solid or liquid, organic or inorganic, monomeric or polymeric, which possess the properties of a Brönstedt or Lewis acid. Examples that may be mentioned are: sulphuric acid, acetic acid, benzoic acid, malonic aid, terephthalic acid, phthalic acid, and also copolyesters or copolyamides whose acid number is at least 20.

If these acids F) are present, their amounts can be from 0.1 to 10% by weight, based on the entire formulation.

Among the polymers G) or oligomers containing hydroxy groups preference is given to use of polyesters, polyethers, polyacrylates, polyurethanes, polyethers and/or polycarbonates whose OH number is from 20 to 500 (in mg KOH/gram) and whose average molar mass is from 250 to 6000 g/mol. These polymers can be amorphous or semicrystalline. Particular preference is given to polyesters containing hydroxy groups whose OH number is from 20 to 150 and whose average molar mass is from 500 to 6 000 g/mol. It is, of course, also possible to use a mixture of these polymers. Polyesters are preferably used as polymer G). The carboxylic acids preferred for the preparation of these polyesters can be of aliphatic, cycloaliphatic, aromatic and/or heterocyclic type and, if appropriate, can have substitution by halogen atoms, and/or unsaturation. Examples of these that may be mentioned are: succinic acid, adipic acid, suberic acid, azelaic acid, sebacic acid, phthalic acid, terephthalic acid, isophthalic acid, trimellitic acid, pyromellitic acid, tetrahydrophthalic acid, hexahydrophthalic acid, hexahydroterephthalic acid, dichlorophthalic acid, tetrachlorophthalic acid, endomethylenetetrahydrophthalic acid, glutaric acid, maleic acid and fumaric acid, and—to the extent that they are obtainable—anhydrides thereof, dimethyl terephthalate, bis(glycol) terephthalate, and moreover cyclic monocarboxylic acids, such as benzoic acid, p-tert-butyl benzoic acid or hexahydrobenzoic acid.

Examples of polyhydric alcohols that can be used to produce the polyester G) are ethylene glycol, propylene 1,2- and 1,3-glycol, butylene 1,4- and 2,3-glycol, di-β-hydroxyethylbutanediol, 1,6-hexanediol, 1,8-octanediol, neopentyl glycol, cyclohexanediol, bis(1,4-hydroxymethyl)propane, 2-methyl-1,3-propanediol, 2-methyl-1,5-pentanediol, 2,2,4(2,4,4)-trimethyl-1,6-hexanediol, glycerol, trimethylolpropane, trimethylolethane, 1,2,6-hexanetriol, 1,2,4-butanetriol, tris(β-hydroxyethyl) isocyanurate, pentaerythritol, mannitol and sorbitol, and also diethylene glycol, triethylene glycol, tetraethylene glycol, dipropylene glycol, polypropylene glycol, polybutylene glycol, xylylene glycol and neopentyl glycol hydroxypivalate.

Other starting materials that can be used to produce the polymers G) are mono- and polyesters composed of lactones, e.g. ε-caprolactone, or hydroxycarboxylic acids, e.g. hydroxypivalic acid, ε-hydroxydecanoic acid, ε-hydroxycapronic acid, thioglycolic acid. Polyesters composed of the abovementioned polycarboxylic acids or their derivatives and of polyphenols, such as hydroquinone, bisphenol A, 4,4′-dihydroxy-biphenyl or bis(4-hydroxyphenyl) sulphone; polyesters of carbonic acid, which are obtainable from hydroquinone, from diphenylolpropane, from p-xylylene glycol, from ethylene glycol, from butanediol or from 1,6-hexanediol and from other polyols via conventional condensation reactions, e.g. using phosgene or diethyl or diphenyl carbonate, or from cyclic carbonates, such as glycol carbonate or vinylidene carbonate, via polymerization in a known manner; polyesters of silicic acid, polyesters of phosphoric acid, e.g. composed of methane-, ethane-, 3-chloroethane-, benzene- or styrenephosphoric acid, or their derivates for example phosphoryl chlorides or phosphoric esters and from polyalcohols or polyphenols of the abovementioned type; polyesters of boric acid; polysiloxanes, e.g. the products obtainable by hydrolysis of dialkyldichlorosilanes with water and subsequent treatment with polyalcohols, the products obtainable by an addition reaction of polysiloxane dihydrides onto olefins, such as allyl alcohol or acrylic acid, are suitable as starting materials for production of the polymer G).

Other preferred polyesters G) are the reaction products of polycarboxylic acids and glycidic compounds, as described by way of example in DE-A 24 10 513.

Examples of glycidyl compounds that can be used are esters of 2,3-epoxy-1-propanol with monobasic acids which have from 4 to 18 carbon atoms, e.g. glycidyl palmitate, glycidyl laurate and glycidyl stearate, alkylene oxides having from 4 to 18 carbon atoms, e.g. butylene oxide, and glycidyl ethers, such as octyl glycidyl ether.

The polyesters G) can be obtained in a manner known per se by condensation in an inert gas atmosphere at temperatures of from 100 to 260° C., preferably from 130 to 220° C., in the melt, or by an azeotropic method, as described by way of example in Methoden der Organischen Chemie [Methods of Organic Chemistry] (Houben-Weyl); Volume 14/2, pages 1 to 5, 21 to 23, 40 to 44, Georg Thieme Verlag, Stuttgart, 1963, or in C. R. Martens, Alkyd Resins, pages 51 to 59, Reinhold Plastics Appl. Series, Reinhold Publishing Comp., New York, 1961.

Other polymers G) that can be used are hydroxy-functional polyethers and polycarbonates. Preferred polyethers can by way of example be produced by polyaddition of epoxides, such as ethylene oxide, propylene oxide, butylene oxide, trimethylene oxide, 3,3-bis(chloromethyl)oxabicyclobutane, tetrahydrofuran, styrene oxide or the bis-(2,5)-epoxypropyl ether of diphenyloipropane, by cationic polymerization in the presence of Lewis acids, e.g. boron trifluoride, or by anionic polymerization using alkali metal hydroxides or alkali metal alcoholates or by an addition reaction of these epoxides, if appropriate in a mixture or in succession, onto the starter components having reactive hydrogen atoms, e.g. alcohols and/or amines, and/or water, in particular ethylene glycol, polypropylene 1,3- or 1,2-glycol, pentamethylene glycol, hexanediol, decamethylene glycol, trimethylolpropane, glycerol, aniline, ammonia, ethanolamine, ethylenediamine, di(β-hydroxy-propyl)methylamine, or else hydroxyalkylated phenols, e.g. di(β-hydroxy-ethoxy)resorcinol.

Polymers G) mentioned by way of example and having carbonate groups, i.e. polycarbonates, can be obtained in a known manner via reaction of dihydric or trihydric alcohols of molar mass range from 62 to 300 g/mol with diaryl carbonates, e.g. diphenyl carbonate, phosgene or preferably cyclic carbonates, e.g. trimethylene carbonate or 2,2-dimethyltrimethylene carbonate (NPC) or a mixture of these cyclic carbonates. Particularly preferred carbonatediols are those which can be prepared, with ring opening, from NPC and, as starter molecules, the dihydric alcohols mentioned.

Other suitable examples of polymers G) are the compounds known per se in polyurethane chemistry from the group of polythioethers, polyacetals, polyepoxides, polyesteramides or polyurethanes of molar mass range from 250 to 8500 g/mol, these having hydroxy groups reactive towards isocyanate groups.

It is, of course, also possible to use a mixture of the abovementioned polymers G).

Suitable monomeric alcohols G) are mono-, di- and/or polyols whose molar mass is at least 32 g/mol.

Examples of the monoalcohols are methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols, and also hydroxymethylcyclohexane.

The diols involved by way of example ethylene glycol, triethylene glycol, 1,4-butanediol, 1,5-pentanediol, 1,6-hexanediol, 3-methyl-1,5-pentanediol, neopentyl glycol, 2,2,4(2,4,4)-trimethylhexanediol, and also neopentyl glycol hydroxypivalate.

The triols involved by way of example trimethylolpropane, ditrimethylolpropane, trimethylolethane, 1,2,6-hexanetriol, 1,2,4-butanetriol, tris(β-hydroxyethyl) isocyanurate, pentaerythritol, mannitol or sorbitol.

If G) is present, its amount, based on the entire formulation, can be from 0.1 to 40% by weight.

Suitable pigments H) for the radiation-curable formulations according to the present invention are described by way of example in “Radiation Curing in Polymer Science & Technology, Vol IV: Practical Aspects and Application” by J. P. Fouassier, J. F. Rabek, Elsevier Applied Science, London and New York, 1993, Chapter 5, pages 87 to 105, and their amounts present can be from 1 to 40% by weight. Examples of corrosion-prevention pigments are found by way of example in Pigment+Füllstoff Tabellen [Pigment+Filler Tables], O. Lückert, Vincentz Verlag Hannover, 6th Edition 2002. Examples that may be mentioned are: SHIELDEX C 303 (Grace Davison) and HALOX Coil X 100, HALOX Coil X 200 and HALOX CW 491 (Erbslöh), HEUCOPHOS SAPP, or else ZPA (Heubach), K-White TC 720 (Tayca) and HOMBICOR (Sachtleben). It is, of course, also possible to use simple inorganic salts, e.g. zinc phosphate, or else colorant pigments. If these pigments are present, their amount varies from 1 to 50% by weight, based on the entire formulation.

Other additives H) for the radiation-curable formulations are available in various compositions and for various purposes, e.g. flow control agents, matting agents, degassing agents, dyes, etc.

Some of these are described in the brochure “SELECTED DEGUSSA PRODUCTS FOR RADIATION CURING AND PRINTING INKS”, published by Tego Coating & Ink Additives, Essen, 2003. If these additives are present, their amount varies from 0.01 to 5% by weight, based on the entire formulation.

Solvents I) that can be used are any of the organic and inorganic liquids which are inert under the reaction conditions. Examples that may be mentioned are acetone, ethyl acetate, butyl acetate, xylene, Solvesso 100, Solvesso 150, methoxypropyl acetate and dibasic esters and water.

If solvents are present, their amount is from 1 to 70% by weight, based on the entire formulation.

The homogenization of all of the constituents to produce the composition of the invention can take place in suitable assemblies, e.g. heatable stirred tanks, kneaders, or else extruders, and the upper temperature limits which should not be exceeded here are from 120 to 130° C.

The well-mixed composition is applied to the substrate by a suitable application method (e.g. roller coating, spraying, dip-coating). After application, the coated workpieces are passed for hardening in the presence of photoinitiators under a UV lamp (with or without inert gas) or in the absence of photoinitiators under an electron-beam curing system (EBCS), and then heated for from 4 to 60 minutes to a temperature of from 60 to 220° C., preferably from 6 to 30 minutes at from 80 to 160° C. In principle, the inverse hardening sequence is also conceivable.

The same thermal hardening without prior radiation-curing is carried out as comparative experiment.

UV curing and UV lamps are described by way of example in “Radiation Curing in Polymer Science & Technology, Vol I: Fundamentals and Methods” by J. P. Fouassier, J. F. Rabek, Elsevier Applied Science, London and New York, 1993, Chapter 8, pages 453 to 503.

Electron-beam curing systems and electron-beam hardening systems are described by way of example in “Radiation Curing in Polymer Science & Technology, Vol I: Fundamentals and Methods” by J. P. Fouassier, J. F. Rabek, Elsevier Applied Science, London and New York, 1993, Chapter 4, pages 193 to 225 and in Chapter 9, pages 503 to 555.

The present invention further provides the use of the thermally curable and radiation-curable formulations according to the invention as coating compositions, in particular as primer, intermediate layer, topcoat material, clear-coat material or sealing material, and also the coating compositions themselves.

The invention also provides the use of the thermally curable and radiation-curable formulations according to the invention for the production of liquid and pulverulent coatings on metal substrates, on plastics substrates, on glass substrates, on wood substrates, or on leather substrates, or on other heat-resistant substrates.

The invention also provides the use of the thermally curable and radiation-curable formulations according to the invention as adhesive compositions for adhesive bonding of metal substrates, of plastics substrates, of glass substrates, of wood substrates, of textile substrates, or of leather substrates, or of other heat-resistant substrates.

The invention likewise provides metal-coating compositions, in particular for automobile bodywork, for motorcycles and peddle cycles, for parts of buildings and for household devices, wood-coating compositions, glass-coating compositions, textile-coating compositions, leather-coating compositions and plastics-coating compositions.

The coating can either be used alone or can be one layer of a multilayer structure. It can by way of example be applied in the form of primer, in the form of intermediate layer, or in the form of topcoat material or clear-coat material. The layers situated over or under the coating can be hardened either by a conventional thermal method or else by radiation.

The present invention is further illustrated below, using examples. Alternative embodiments of the present invention are obtainable by an analogous method.

### EXAMPLES

| Starting materials | Product description, producer |
|---|---|
| IPDI | Isophorone diisocyanate, Evonik Degussa GmbH, Coatings & |
| | Colorants |
| IPDI uretdione | IPDI-based uretdione, Evonik Degussa GmbH, Coatings & |
| | Colorants, free NCO content 17.2%, total NCO 36% |
| Dynapol R 110 | radiation-curable resin (urethane acrylate) in 25% of isobornyl |
| | acrylate, Evonik Degussa GmbH, Coatings & Colorants (A) |
| VESTAGON EP BF | Hardening agent, uretdione content: from 11.5 to 13.0%, |
| 9030 | melting point: from 74 to 75° C., T_{G}: from 40 to 50° C., Evonik |
| | Degussa GmbH, Coatings & Colorants (B) |
| HEA | Hydroxyethyl acrylate, Evonik Degussa GmbH |
| LAROMER 8887 | Trimethylolpropane monoformal acrylate, BASF, monofunctional |
| | reactive diluent (A) |
| IRGACURE 184 | Photoinitiator, Ciba (E) |
| ARALDITE PT 912 | Co-catalyst, glycidyl ester, Huntsman (C1) |
| Zinc acetylacetonate | Co-catalyst, Aldrich (C2) |
| TEAB | Tetraethylammonium benzoate, RSA Corp. (C) |
| DBTL | Dibutyltin dilaurate, catalyst, Aldrich |

### A) Production of Radiation-Curable Resin

### A1) Polyester Production

Adipic acid (292 g) and butanediol (295 g) are melted in a stream of nitrogen, in a 2 l flask with distillation head. When a temperature of 160° C. is reached, water begins to distil over. Within a period of one hour, the temperature is successively increased to 220° C. After four further hours at this temperature, water elimination becomes slower. 200 mg of FASCAT 4102 (transesterification catalyst from Arkema) are incorporated by stirring and the process is continued under a vacuum which during the course of the reaction is adjusted in such a way that production of distillate always continues. The process ends after a hydroxy number of 250 mg KOH/g (DIN 53240-2 method) and an acid number of 0.6 mg KOH/g (DIN EN ISO 2114 method) has been reached. Viscosity (80° C.): 41 mPas.

### A2) Acrylation of A1

139 g of HEA and 224 g of the polyester A1 were added to 222 g of IPDI. After addition of 0.7 g of IONOL CP and 0.1 g of DBTL, the mixture is heated to 60° C., with stirring, and then stirred at this temperature for 5 h. After this, the NCO number has fallen to <01%.

### B) Preparation of Uretdione-Containing Component

408 g of IPDI uretdione (free NCO number 17.2%) is dissolved in 500 ml of ethyl acetate; 72 g of hexanediol and 71 g of HEA are admixed. After addition of 0.3 g of Ionol CP and 0.1 g of DBTL, the mixture is heated to 60° C., and cooled after 5 h. Free NCO content has fallen to <0.1%. The solvent is drawn off on a rotary evaporator, and the product is a white crystalline solid.

### C) Formulations

All data in % by weight are based on the total weight of the formulation

| Experiment/component | 1 | 2* | 3 | 4* | 5 |
|---|---|---|---|---|---|
| Dynapol R 110 (A) | | | 32 | 33 | 32 |
| VESTAGON BF 9030 (B) | | | 33 | 33 | 33 |
| Radiation-curable resin (A) | 30 | 30 | | | |
| LAROMER 8887 (A) | 40 | 42 | 33 | 34 | 33 |
| Uretdione component (B) | 20 | 20 | | | |
| IRGACURE 184 (E) | 8 | 8 | — | | |
| TEAB (C) | 1 | — | 1 | | 1 |
| Zinc acetylacetonate (C2) | | | | | 1 |
| ARALDITE PT 912 (C1) | 1 | — | 1 | | |

*comparative examples not according to the invention

### D) Results

### General Production Specification for the Formulation and Hardening of UV Coatings

All of the constituents of the formulation were combined and stirred by a magnetic stirrer for 20 min.

The ready-to-use formulation is applied by doctor blade at a layer thickness of from 20 to 25 μm to a steel sheet (Bonder 1303 sheet) and then in case 1 and 2* hardened under a UV lamp (3 m/min, Minicure, mercury vapour lamp, 80 W/cm, Technigraf). In cases 3 and 4, the hardening takes place under electron beams (EBCS, 10 Mrad, equipment from ESI), since no photoinitiators are present. Thermal curing in a convection oven at 150° C. (30 min) follows this in all cases. In case b), thermal hardening takes place without prior radiation curing.

| | 1a) UV + 30 min | 1b) 30 min |
|---|---|---|
| Experiment 1 | 150° C. | 150° C. |
| Erichsen indentation [mm] | 8.5 | 9.0 |
| Ball impact (dir./rev.) | >80/>80 | 60/40 |
| [inch × lbs] | | |
| MEK test [cycles] | >100 | 38 |
| Freedom from tack | yes | yes |

| | 2a) UV + 30 min | 2b) 30 min |
|---|---|---|
| Experiment 2* | 150° C. | 150° C. |
| Erichsen indentation [mm] | 9.0 | 9.0 |
| Ball impact (dir./rev.) | 30/<10 | 20/<10 |
| [inch × lbs] | | |
| MEK test [cycles] | 57 | 2 |
| Freedom from tack | yes | no |

*comparative examples not according to the invention

| | 3a) EBCS + 30 min | 3b) 30 min |
|---|---|---|
| Experiment 3 | 150° C. | 150° C. |
| Erichsen indentation | 9.5 | 10.0 |
| [mm] | | |
| Ball impact (dir./rev.) | >80/>80 | >80/>80 |
| [inch × lbs] | | |
| MEK test [cycles] | >100 | 23 |
| Freedom from tack | yes | yes |

| | 4a) UV + 30 min | 4b) 30 min |
|---|---|---|
| Experiment 4* | 150° C. | 150° C. |
| Erichsen indentation | 10.0 | 9.0 |
| [mm] | | |
| Ball impact (dir./rev.) | 50/<10 | 50/<10 |
| [inch × lbs] | | |
| MEK test [cycles] | 70 | 1 |
| Freedom from tack | yes | no |

*comparative examples not according to the invention

| | 5a) EBCS + 30 | 5b) 30 min |
|---|---|---|
| Experiment 5 | min 150° C. | 150° C. |
| Erichsen indentation | 10.0 | 10.0 |
| [mm] | | |
| Ball impact (dir./rev.) | >80/>80 | >80/>80 |
| [inch × lbs] | | |
| MEK test [cycles] | >100 | 34 |
| Freedom from tack | yes | yes |

### Erichsen Indentation to DIN 53156, Ball Impact to ASTM D2794-93

The formulations according to the invention are superior in all of the coatings data to the formulations not according to the invention. More particularly, the formulation according to the invention exhibits a minimum extent of coating properties after thermal curing even without prior radiation curing: freedom from tack, flexibility (Erichsen indentation >7 mm) and chemicals resistance (MEK test >20 cycles).

1. A thermally curable and radiation-curable formulation comprising
A) from 5 to 90% by weight of at least one radiation-curable component, which optionally comprises OH groups,
B) from 10 to 90% by weight of at least one component comprising uretdione groups, which optionally comprises at least one of OH groups and radiation-curable groups,
C) from 0.1 to 5% by weight of at least one of tetralkylammonium salt and phosphonium salt with at least one of halogens, hydroxides, alcoholates and organic or inorganic acid anions, as counter-ion,
and
from 0.1 to 5% by weight of at least one co-catalyst, selected from the group consisting of
C1) at least one epoxide
and
C2) at least one metal acetylacetonate.

2. The thermally curable and radiation-curable formulation according to claim 1,
wherein
the formulation further comprises at least one of following components, alone or in a mixture:
D) from 0.1 to 10% by weight of at least one adhesion promoter,
E) from 0.2 to 10% by weight of at least one photoinitiator,
F) from 0.1 to 10% by weight of at least one acid,
G) from 1 to 40% by weight of at least one of monomers, polymers and oligomers comprising hydroxy groups,
H) from 0.01 to 50% by weight of at least one of pigment and other additives,
I) from 1 to 70% by weight of at least one solvent.

3. The thermally curable and radiation-curable formulation according to claim 1,
wherein
the component A) present comprises at least one of epoxy acrylates, polyester acrylates, polyether acrylates, polyacrylate acrylate, urethane acrylates and polyester urethane acrylates, alone or in a mixture.

4. The thermally curable and radiation-curable formulation according to claim 1,
wherein
the component A) present comprises a polyester urethane acrylate.

5. The thermally curable and radiation-curable formulation according to claim 1,
wherein
the component A) present comprises a reactive diluent.

6. The thermally curable and radiation-curable formulation according to claim 5,
wherein
the formulation comprises isobornyl acrylate, hydroxypropyl methacrylate, trimethylolpropane monoformal acrylate, tetrahydrofurfuryl acrylate, phenoxyethyl acrylate, trimethylenepropane triacrylate, dipropylene glycol diacrylate, tripropylene glycol diacrylate, hexanediol diacrylate, pentaerythritol tetraacrylate, lauryl acrylate, or else propoxylated or ethoxylated variants of these reactive diluents and/or urethanized reactive diluents, vinyl ether or allyl ether.

7. The thermally curable and radiation-curable formulation according to claim 6,
wherein
the formulation comprises at least one of isobornyl acrylate and trimethylolpropane monoformal acrylate.

8. The thermally curable and radiation-curable formulation according to claim 1,
wherein
component B) comprises an uretdione group and based on isophorone diisocyanate (IPDI), at least one of hexamethylene diisocyanate (HDI), dicyclohexylmethane 2,2′-diisocyanate/dicyclohexylmethane 2,4′-diisocyanate/dicyclohexylmethane 4,4′-diisocyanate (H₁₂MDI), 2-methyl pentadiisocyanate (MPDI), trimethylhexamethylene 2,2,4-diisocyanate/trimethylhexamethylene 2,4,4-diisocyanate (TMDI), norbornane diisocyanate (NBDI), methylenediphenyl diisocyanate (MDI), toluidine diisocyanate (TDI) and tetramethylxylylene diisocyanate (TMXDI), alone or in a mixture.

9. The thermally curable and radiation-curable formulation according to claim 8,
characterized in that
component B) comprises an uretdione group and based on IPDI, at least one of 4,4′-H₁₂MDI and HDI are present.

10. The thermally curable and radiation-curable formulation according to claim 1,
component B) has an uretdione group and, based on, alone or in a mixture, at least one of monoalcohols, monoamines, tetra-, tri-, and dialcohols of low molecular weight, polyurethanes, polyesteramides, polyepoxides, polycaprolactones, polyethers, polythioethers, and polyesters comprising hydroxy groups.

11. The thermally curable and radiation-curable formulation according to claim 10,
wherein
the formulation comprises at least one of polyesters and monomeric dialcohols.

12. The thermally curable and radiation-curable formulation according to claim 1,
wherein
the component B) comprising an uretdione group has less than 5% by weight of free NCO content and from 6 to 25% by weight content of uretdione groups (calculated as C₂N₂O₂, molecular weight 84).

13. The thermally curable and radiation-curable formulation according to claim 1,
wherein
the component B) comprising an uretdione groups also has at least one of isocyanurate structures, biuret structures, allophanate structures, urethane structures and urea structures.

14. The thermally curable and radiation-curable formulation according to claim 1,
wherein
the component C) present comprises at least one of tetramethylammonium formate, tetramethylammonium acetate, tetramethylammonium propionate, tetramethylammonium butyrate, tetramethylammonium benzoate, tetraethylammonium formate, tetraethylammonium acetate, tetraethylammonium propionate, tetraethylammonium butyrate, tetraethylammonium benzoate, tetrapropylammonium formate, tetrapropylammonium acetate, tetrapropylammonium propionate, tetrapropylammonium butyrate, tetrapropylammonium benzoate, tetrabutylammonium formate, tetrabutylammonium acetate, tetrabutylammonium propionate, tetrabutylammonium butyrate and tetrabutylammonium benzoate and tetrabutylphosphonium acetate, tetrabutylphosphonium formate and ethyltriphenylphosphonium acetate, tetrabutylphosphonium benzotriazolate, tetraphenylphosphonium phenolate and trihexyltetradecylphosphonium decanoate, methyltributylammonium hydroxide, methyltriethylammonium hydroxide, tetramethylammonium hydroxide, tetraethylammonium hydroxide, tetrapropylammonium hydroxide, tetrabutylammonium hydroxide, tetrapentylammonium hydroxide, tetrahexylammonium hydroxide, tetraoctylammonium hydroxide, tetradecylammonium hydroxide, tetradecyltrihexylammonium hydroxide, tetraoctadecylammonium hydroxide, benzyltrimethylammonium hydroxide, benzyltriethylammonium hydroxide, trimethylphenylammonium hydroxide, triethylmethylammonium hydroxide, trimethylvinylammonium hydroxide, methyltributylammonium methanolate, methyltriethylammonium methanolate, tetramethylammonium methanolate, tetraethylammonium methanolate, tetrapropylammonium methanolate, tetrabutylammonium methanolate, tetrapentylammonium methanolate, tetrahexylammonium methanolate, tetraoctylammonium methanolate, tetradecylammonium methanolate, tetradecyltrihexylammonium methanolate, tetraoctadecylammonium methanolate, benzyltrimethylammonium methanolate, benzyltriethylammonium methanolate, trimethylphenylammonium methanolate, triethylmethylammonium methanolate, trimethylvinylammonium methanolate, methyltributylammonium ethanolate, methyltriethylammonium ethanolate, tetramethylammonium ethanolate, tetraethylammonium ethanolate, tetrapropylammonium ethanolate, tetrabutylammonium ethanolate, tetrapentylammonium ethanolate, tetrahexylammonium ethanolate, tetraoctylammonium methanolate, tetradecylammonium ethanolate, tetradecyltrihexylammonium ethanolate, tetraoctadecylammonium ethanolate, benzyltrimethylammonium ethanolate, benzyltriethylammonium ethanolate, trimethylphenylammonium ethanolate, triethylmethylammonium ethanolate, trimethylvinylammonium ethanolate, methyltributylammonium benzylate, methyltriethylammonium benzylate, tetramethylammonium benzylate, tetraethylammonium benzylate, tetrapropylammonium benzylate, tetrabutylammonium benzylate, tetrapentylammonium benzylate, tetrahexylammonium benzylate, tetraoctylammonium benzylate, tetradecylammonium benzylate, tetradecyltrihexylammonium benzylate, tetraoctadecylammonium benzylate, benzyltrimethylammonium benzylate, benzyltriethylammonium benzylate, trimethylphenylammonium benzylate, triethylmethylammonium benzylate, trimethylvinylammonium benzylate, tetramethylammonium fluoride, tetraethylammonium fluoride, tetrabutylammonium fluoride, tetraoctylammonium fluoride, benzyltrimethylammonium fluoride, tetrabutylphosphonium hydroxide, tetrabutylphosphonium fluoride, tetrabutylammonium chloride, tetrabutylammonium bromide, tetrabutylammonium iodide, tetraethylammonium chloride, tetraethylammonium bromide, tetraethylammonium iodide, tetramethylammonium chloride, tetramethylammonium bromide, tetramethylammonium iodide, benzyltrimethylammonium chloride, benzyltriethylammonium chloride, benzyltripropylammonium chloride, benzyltributylammonium chloride, methyltributylammonium chloride, methyltripropylammonium chloride, methyltriethylammonium chloride, methyltriphenylammonium chloride, phenyltrimethylammonium chloride, benzyltrimethylammonium bromide, benzyltriethylammonium bromide, benzyltripropylammonium bromide, benzyltributylammonium bromide, methyltributylammonium bromide, methyltripropylammonium bromide, methyltriethylammonium bromide, methyltriphenylammonium bromide, phenyltrimethylammonium bromide, benzyltrimethylammonium iodide, benzyltriethylammonium iodide, benzyltripropylammonium iodide, benzyltributylammonium iodide, methyltributylammonium iodide, methyltripropylammonium iodide, methyltriethylammonium iodide, methyltriphenylammonium iodide and phenyltrimethylammonium iodide, methyltributylammonium hydroxide, methyltriethylammonium hydroxide, tetramethylammonium hydroxide, tetraethylammonium hydroxide, tetrapropylammonium hydroxide, tetrabutylammonium hydroxide, tetrapentylammonium hydroxide, tetrahexylammonium hydroxide, tetraoctylammonium hydroxide, tetradecylammonium hydroxide, tetradecyltrihexylammonium hydroxide, tetraoctadecylammonium hydroxide benzyltrimethylammonium hydroxide, benzyltriethylammonium hydroxide, trimethylphenylammonium hydroxide, triethylmethylammonium hydroxide, trimethylvinylammonium hydroxide, tetramethylammonium fluoride, tetraethylammonium fluoride, tetrabutylammonium fluoride, tetraoctylammonium fluoride and benzyltrimethylammonium fluoride, alone or in a mixture.

15. The thermally curable and radiation-curable formulation according to claim 14,
wherein
the component C) present comprises tetraethylammonium benzoate or tetrabutylammonium hydroxide.

16. The thermally curable and radiation-curable formulation according to claim 1,
wherein
the component C1) present comprises at least one of glycidyl ethers, glycidyl esters, aliphatic epoxides, diglycidyl ethers comprising bisphenol A and glycidyl methacrylates.

17. The thermally curable and radiation-curable formulation according to claim 16,
wherein
the formulation comprises at least one of triglycidyl isocyanurate, a mixture comprising diglycidyl terephthalate and triglycidyl trimellitate, glycidyl ester of Versatic acid, 3,4-epoxycyclohexylmethyl 3′,4′-epoxycyclohexanecarboxylate (ECC), diglycidyl ether based on bisphenol A, ethylhexyl glycidyl ether, butyl glycidyl ether, pentaerythritol tetraglycidyl ether, or other Polypox grades having free epoxy groups, alone or in a mixture thereof.

18. The thermally curable and radiation-curable formulation according to claim 1,
wherein
the component C2) present comprises at least one of zinc acetylacetonate, lithium acetylacetonate and tin acetylacetonate, alone or in a mixture.

19. The thermally curable and radiation-curable formulation according to claim 1,
wherein
the component D) present comprises at least one of phosphoric acid, phosphonic acid, and reaction products thereof with functionalized acrylates.

20. The thermally curable and radiation-curable formulation according to claim 1,
wherein
the component F) present comprises at least one of sulphuric acid, acetic acid, benzoic acid, malonic acid, terephthalic acid, phthalic acid, copolyesters and copolyamides whose acid number is at least 20.

21. The thermally curable and radiation-curable formulation according to claim 1,
wherein
the component G) present comprises at least one of polyesters, polyethers, polyacrylates, polyurethanes, polyethers and polycarbonates whose OH number is from 20 to 500 (in mg KOH/gram) and whose average molar mass is from 250 to 6000 g/mol.

22. The thermally curable and radiation-curable formulation according to claim 1,
wherein
the component G) present comprises polyesters which comprise hydroxy groups and whose OH number is from 20 to 150 and whose average molar mass is from 500 to 6000 g/mol.

23. The thermally curable and radiation-curable formulation according to claim 1,
wherein
the component G) present comprises a reaction product of polycarboxylic acid and glycidic compound.

24. The thermally curable and radiation-curable formulation according to claim 1,
wherein
the component G) present comprises at least one of polythioethers, polyacetals, polyepoxides, polyesteramides and polyurethanes of molar mass range from 250 to 8500 g/mol, which have hydroxy groups reactive towards isocyanate groups.

25. The thermally curable and radiation-curable formulation according to claim 1,
wherein
the component G) present comprises at least one of mono-, di-, and polyols whose molar mass is at least 32 g/mol.

26. A process for production of thermally curable and radiation-curable formulations according to claim 1, wherein the formulation comprises
A) from 5 to 90% by weight of at least one radiation-curable component, which optionally comprises OH groups,
B) from 10 to 90% by weight of at least one component comprising uretdione groups, which optionally comprises at least one of OH groups and radiation-curable groups,
C) from 0.1 to 5% by weight of at least one of tetralkylammonium salt and phosphonium salt with halogens, hydroxides, alcoholates or organic or inorganic acid anions, as counter-ion,
and
from 0.1 to 5% by weight of at least one co-catalyst, selected from the group consisting of
C1) at least one epoxide
and optionally
C2) at least one metal acetylacetonate, and
wherein the process comprises homogenizing the formulation at an upper temperature limit of from 120 to 130° C.

27. A coating composition, comprising the thermally curable and radiation-curable formulation according to claim 1, comprising
A) from 5 to 90% by weight of at least one radiation-curable component, which optionally comprises OH groups,
B) from 10 to 90% by weight of at least one component comprising uretdione groups, which optionally comprises OH groups and/or radiation-curable groups,
C) from 0.1 to 5% by weight of at least one of tetralkylammonium salt and phosphonium salt with halogens, hydroxides, alcoholates or organic or inorganic acid anions, as counter-ion,
and
from 0.1 to 5% by weight of at least one co-catalyst, selected from the group consisting of
C1) at least one epoxide
and optionally
C2) at least one metal acetylacetonate.

28. A sealing material comprising the composition according to claim 27.

29. A heat-resistant substrate comprising the composition according to claim 27.

30. A coating composition comprising thermally curable and radiation-curable formulations according to claim 1, comprising
A) from 5 to 90% by weight of at least one radiation-curable component, which optionally comprises OH groups,
B) from 10 to 90% by weight of at least one component containing uretdione groups, which can also contain OH groups and/or radiation-curable groups,
C) from 0.1 to 5% by weight of at least one tetralkylammonium salt and/or phosphonium salt with halogens, hydroxides, alcoholates or organic or inorganic acid anions, as counter-ion,
and
from 0.1 to 5% by weight of at least one co-catalyst, selected from the group consisting of
C1) at least one epoxide
and
C2) at least one metal acetylacetonate.

31. A metal-coating composition, comprising a thermally curable and radiation-curable formulation comprising
A) from 5 to 90% by weight of at least one radiation-curable component, which optionally comprises OH groups,
B) from 10 to 90% by weight of at least one component comprising uretdione groups, which optionally comprises OH groups and/or radiation-curable groups,
C) from 0.1 to 5% by weight of at least one of tetralkylammonium salt and phosphonium salt with halogens, hydroxides, alcoholates or organic or inorganic acid anions, as counter-ion,
and
from 0.1 to 5% by weight of at least one co-catalyst, selected from the group consisting of
C1) at least one epoxide
and optionally
C2) at least one metal acetylacetonate.

32. A wood-coating composition, comprising a thermally curable and radiation-curable formulations comprising
A) from 5 to 90% by weight of at least one radiation-curable component, which optionally comprises OH groups,
B) from 10 to 90% by weight of at least one component containing uretdione groups, which optionally comprises OH groups and/or radiation-curable groups,
C) from 0.1 to 5% by weight of at least one of tetralkylammonium salt and phosphonium salt with halogens, hydroxides, alcoholates or organic or inorganic acid anions, as counter-ion,
and
from 0.1 to 5% by weight of at least one co-catalyst, selected from the group consisting of
C1) at least one epoxide
and optionally
C2) at least one metal acetylacetonate.

33. A leather-coating composition or textile-coating composition, comprising a thermally curable and radiation-curable formulation comprising
A) from 5 to 90% by weight of at least one radiation-curable component, which optionally comprises OH groups,
B) from 10 to 90% by weight of at least one component comprising uretdione groups, which optionally comprises OH groups and/or radiation-curable groups,
C) from 0.1 to 5% by weight of at least one of tetralkylammonium salt and phosphonium salt with halogens, hydroxides, alcoholates or organic or inorganic acid anions, as counter-ion,
and
from 0.1 to 5% by weight of at least one co-catalyst, selected from the group consisting of
C1) at least one epoxide
and optionally
C2) at least one metal acetylacetonate.

34. A plastic-coating composition or glass-coating composition, comprising a thermally curable and radiation-curable formulation comprising
A) from 5 to 90% by weight of at least one radiation-curable component, which optionally comprises OH groups,
B) from 10 to 90% by weight of at least one component containing uretdione groups, which optionally comprises at least one of OH groups and radiation-curable groups,
C) from 0.1 to 5% by weight of at least one tetralkylammonium of salt and phosphonium salt with halogens, hydroxides, alcoholates or organic or inorganic acid anions, as counter-ion,
and
from 0.1 to 5% by weight of at least one co-catalyst, selected from
C1) at least one epoxide
and optionally
C2) at least one metal acetylacetonate.

35. An automobile bodywork comprising the metal-coating composition according to claim 31.

36. A coating composition comprising the formulation according to claim 2.

37. A metal-coating composition comprising the formulation according to claim 3.
